(19) United States
(12) Patent Application Publication
(10) Pub. No.: US 2026/0192317 A1
(43) Pub. Date: Jul. 9, 2026

(54) Equipment for Coloring And Decorating Concrete Pavement Tread Layers

(71) Applicant: AGSTAV TREBIC, A.S., Trebic (CZ)

(72) Inventor: Petr HASÍK, Caslav (CZ)

(21) Appl. No.: 19/128,072

(22) PCT Filed: Nov. 6, 2023
(86) PCT No.: PCT/CZ2023/000042

§ 371 Date: May 7, 2025

(51) Int. Cl. B05B 12/02; B05B 13/02

(52) U.S. Cl. CPC B05B 12/02; B05B 13/0221

(57) ABSTRACT

An apparatus for coloring and decorating concrete pavement tread layers, comprising a vibropress with a punch, hoppers for tread and core concrete, transport carriages for tread and core concrete and a mold of the product, the apparatus having programmable paint nozzles for coloring and decorating the tread layer installed on a moveable arm in a space between the vibropress punch and the mold.

### FIELD OF THE INVENTION

The equipment for coloring and decorating concrete pavers refers to the production of tread layers of concrete pavers on vibro press machines, for use outdoors.

### BACKGROUND OF THE INVENTION

Equipment for coloring and decorating concrete pavement tread layers known so far include several production nodes. Simply put, the main part of the equipment is a commonly produced vibropress machine with a punch, which rams the concrete mass into a mold representing the desired shape of the product. A transverse brush is attached to the frame of the press, which is intended for cleaning the punch during the production of special products. It is mostly not used in the production of pavers, it is usually dismantled. The transverse brush consists of a fixed and a movable part. The fixed part is attached to the frame of the press and the movable part moves from side to side. The larger part of the concrete mass in the mold is core concrete, which is transferred from the core concrete hopper to the lower part of the mold by the core concrete carriage. After compacting the core concrete with the punch of the vibropress machine, the tread concrete is transferred from the tread concrete hopper by a carriage, poured into the mold and pressed into the form of product by the punch. The colour of the tread layer is achieved by mixing coloured concrete in a mixer, or by mixing two or more coloured concretes in a hopper, in equipment called colormix. To create a plastic, raised surface of the product, the punch of the vibropress machine is equipped with a relief. After pressing, the product is transferred to the curing chamber, where it reaches the required strength for further handling during the curing of the concrete. After taking the product out of the curing chambers, the visible side of the product can be subjected to other required treatments-painting, grinding, brushing, etc.

However, the aforementioned equipment for coloring the tread layers of concrete products does not allow the regulation of colour saturation and the use of a larger number of individual colours on the production substrate. Its other disadvantage is the high consumption of colour pigments due to the coloring of the tread layer in the entire volume.

The production of a raised surface in such equipment is financially expensive, due to the need to purchase a relief punch, which is only worthwhile for a large number of products. Another disadvantage of using this decoration of the paver tread layer is the unevenness of their surface, which makes it difficult to maintain these surfaces.

The above-mentioned disadvantages are eliminated by a vibropress with a punch, which consists of hoppers for tread and core concrete, carriages for tread and core concrete and a product mold, according to a technical solution, the essence of which is that a set of paint nozzles and/or individual paint nozzles are installed in the space between the punch of the vibropress and the mold. The paint nozzles are installed either as a set on a movable carrier, which is attached to a brush holder fixed on the frame, or individually on the vibropress frame, or on an additional structure at the frame vibropress. A die roller or a set of two die rollers is attached to the front of the tread concrete carriage, which is moved over the product mold. The roller or the roller set can also be installed inside the carriage.

Equipment for coloring and decorating concrete pavement tread layers enables arbitrary coloring and selection of various decorations of tread layers of concrete pavements, curbs and small prefabs produced on vibropresses according to customer wishes. The resulting coloured tread or coloured tread with decor reduces the cost of producing concrete pavers and allows for greater variability.

### SUMMARY OF THE INVENTION

In one aspect, the invention comprises:
An apparatus for coloring concrete pavement tread layers comprising:
hoppers for core concrete and tread concrete,
a vibropress with a frame and a punch located above the vibropress, there being a space defined between the vibropress and the punch, and a moveable carrier connected to the frame,
carriages for transporting the core concrete and the tread concrete from the hoppers to the vibropress,
a product mold placeable upon the vibropress for receiving the core concrete and the tread concrete from the carriages and configured for receiving a pressing action from the punch, and,
a paint applicator installed on the moveable carrier, wherein the paint applicator is operable within the space between the vibropress and the punch.

In another aspect of the invention, the invention comprises:
An apparatus for decorating concrete pavement tread layers comprising:
a hopper for core concrete and a hopper for tread concrete,
a vibropress with a frame and a punch located above the vibropress, there being a space defined between the vibropress and the punch, and a moveable carrier connected to the frame,
a core concrete carriage for transporting the core concrete from the hopper for core concrete to the vibropress,
a tread concrete carriage for transporting the tread concrete from the hopper for tread concrete to the vibropress, the tread concrete carriage comprising a roller die for delivering imprinted tread concrete to the vibropress,
a product mold placeable upon the vibropress for receiving the core concrete from the core concrete carriage and the imprinted tread concrete from the tread concrete carriage and configured for receiving a pressing action from the punch, and
a paint applicator installed on the moveable carrier, wherein the paint applicator is operable within the space between the vibropress and the punch.

### BRIEF DESCRIPTION OF THE DRAWINGS

The above equipment is shown schematically in the attached figures:

FIG. 1— side view of the entire equipment including hoppers;

FIG. 2— front view of the vibropress machine with nozzles;

FIG. 3— top view of the mounting of the cross brush holder with the carrier;

FIG. 4— equipment where a die roller is attached to a tread concrete carriage;

FIG. 5— set of rollers with a die; and

FIGS. 6 and 7 represent the possibilities of installing the decorating roller in the carriage or on its front side.

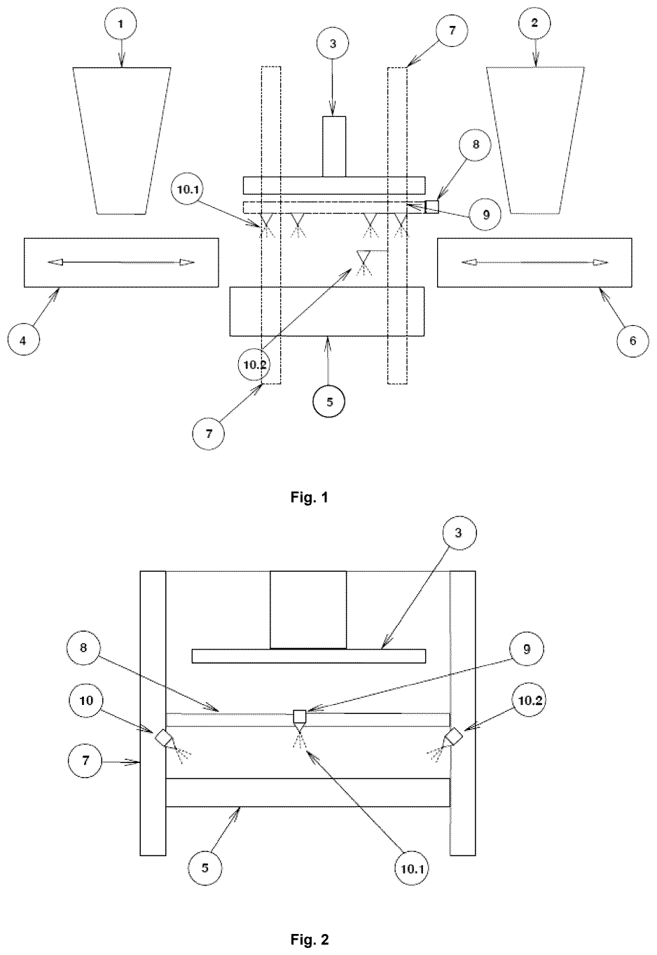

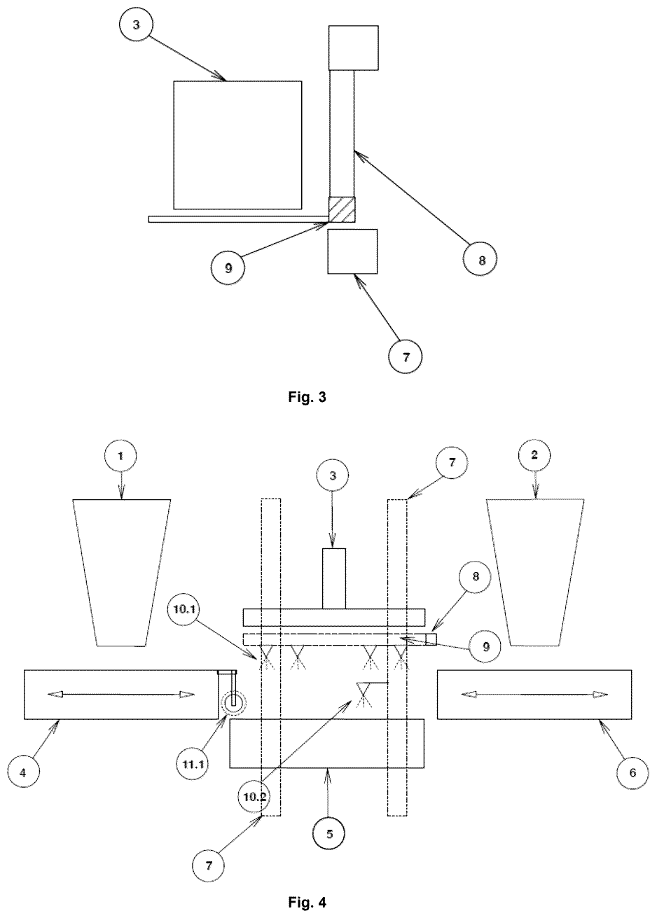

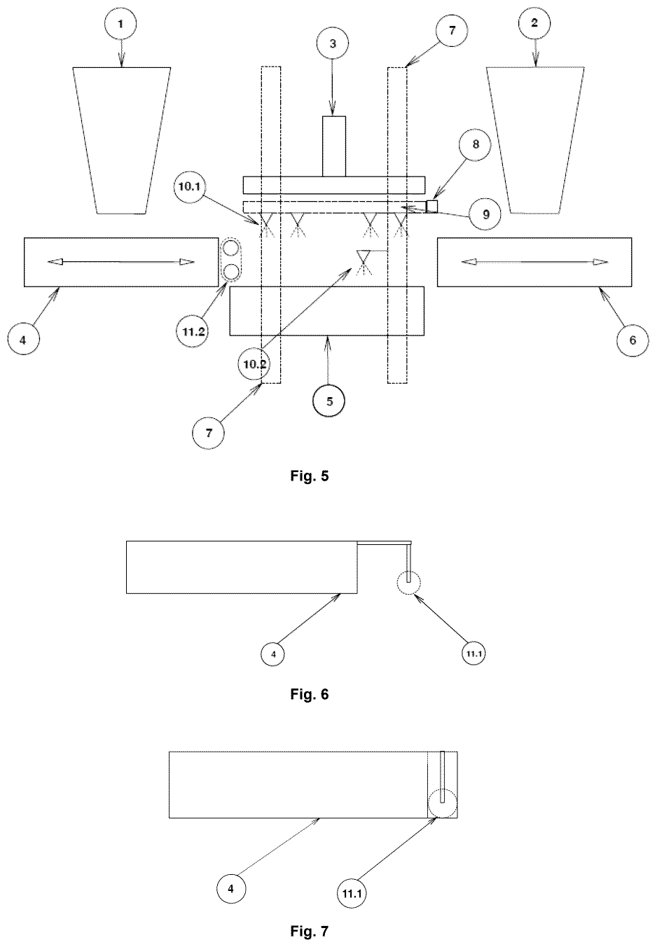

### DETAILED DESCRIPTION OF THE INVENTION

Reference will now be made in detail to the presently preferred embodiments of the invention. There are also representative examples of the invention illustrated in the accompanying drawings. Throughout the following detailed description, the same reference numeral refers to the same elements in all figures. The present disclosure, however, may be embodied in various forms, and should not be construed as being limited to only the illustrated embodiments herein. Rather, these embodiments are provided as examples so that this disclosure will be thorough and complete, and will fully convey the aspects and features of the present disclosure to those skilled in the art.

The description provided herein is not intended to limit the claims to the specific embodiments so described. On the contrary, it is intended to cover alternatives, modifications, and equivalents as may be included within the spirit and scope of the present disclosure as defined by the appended claims.

Although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, methods, operations, elements, and/or components, but do not preclude the presence or addition of one or more other features, integers, methods, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. In addition, terms such as those defined in commonly used dictionaries, should be interpreted as having a meaning that is consistent with their meaning in the context of the relevant art and will not be interpreted in an idealized or overly formal sense unless express so defined herein.

In the following description, numerous specific details are set forth in order to provide a thorough understanding of the present disclosure. The present disclosure may be practiced without some or even all of these specific details. In other instances, well-known process structures and/or processes have not been described in detail in order not to unnecessarily obscure the present disclosure. Further, the use of “may” when describing embodiments of the present disclosure refers to “one or more embodiments of the present disclosure.”

Good example of implementation is equipment for coloring and decorating concrete pavement tread layers, the main part of which is a locally acquired vibropress. On one side of the vibropress there is a tread concrete hopper 1 with a carriage 4 of tread concrete below it. On the other side of the vibropress there is a core concrete hopper 2 with a core concrete carriage 6 below it. Both carriages 4 and 6 are moved above the mold 5. The main part of the vibropress is the frame 7, in which the punch 3 of the vibropress is moved vertically against the mold 5. From the side, in the space between the punch 3 and the mold 5, the holder 8 with the drive for the carrier 9 of the transverse brush is firmly attached to the vibropress frame 7. The transverse brush carrier 9 is moved horizontally above the mold 5. In the rest position the carrier 9 is placed on the right or left side of the vibropress frame 7, outside the working area of the punch 3. The transverse brush is primarily intended for cleaning the punch 3 during the production of special products. In the case of technical solution, the paint nozzles set 10.1 is installed on the carrier 9. The paint nozzles 10.2 can also be placed on the vibropress frame 7, or on the additional structure at the frame 7. The location of the individual nozzles 10.2 and the set of nozzles 10.1 can be combined in different ways, according to the colour requirement of the product.

To create the decor on the product, a roller 11.1 with a die or a set of rollers with a die is attached to the front part of the tread concrete carriage 4. A variant arrangement is to install the roller 11.1 with the die or the set 11.2 of the rollers with the die inside the tread concrete carriage 4.

The equipment function according to the technical solution is as follows. From the core concrete hopper 2, the material is poured into the core concrete carriage 6, from which it is transported to the mold 5. The core concrete forms the greater part of the concrete mass of the paver. After tamping with the vibropress punch 3, the tread concrete is transferred from the hopper 1 by the carriage 4. It is poured into the product mold 5 and pressed with the punch 3. The vibropress punch 3 rams the concrete mass in the mold 5, representing the desired shape of the product.

The transverse brush holder 8 is attached to the vibropress frame 7 and its movable part, the carrier 9, moves from side to side in the space between the punch 3 and the mold 5. In the production of pavers, the brush is mostly not used. It is usually dismantled from mass-produced vibropresses. The carrier 9 is used for the installation of the set of paint nozzles 10, which can be placed individually as paint nozzles 10.2 on the vibropress frame 7.

### a) Paver Coloring

After loading the tread concrete into the mold 5, before the main vibrations, one or more colours are applied to the tread layer, by means of a set 10.1 of nozzles installed on the carrier 9 and possibly paint nozzles 10.2 on the vibropress frame 7.

Spraying of non-compacted tread concrete with a layer of coloured pigments mixed with a suitable carrier, such as water, acrylic, silicates, etc., is carried out by nozzles connected to a paint pump with a paint reservoir. The set 10.1 of paint nozzles, which are located on the carrier 9, moves based on the control program of the carrier 9. The individual nozzles 10.2 are switched on automatically on the basis of a separate spraying colour control program or the nozzles 10.2 are switched on manually by the vibropress operator. The application of paint to the non-compacted tread layer must be done before the main vibration, so that the pigment penetrates the surface of the tread layer to a depth of several microns to millimetres. This ensures permanent coloring of the surface of the concrete pavers.

### b) Paver Decoration

The decor is made on the product with a die that embosses a relief pattern into the surface of the product. The die of the desired decoration shape is created on the roller 11 with the die. Depending on the complexity of the decor, a single roller 11.1 or a set of rollers 11.2 is used, which are placed either on the front part of the tread concrete carriage 4 or inside the carriage 4. The movement of the roller 11.1 or the rollers 11.2 is ensured by the carriage 4 loading the tread concrete into the mold 5. While the carriage 4 is moving back to the parking position, the rollers 11.1 or 11.2 imprint their die into the tread concrete in the mold 5. A single roller is used in the event that the length of the repeating decor up to approx. 20 cm is sufficient. If a longer repetition of the pattern is needed, it is necessary to use two rollers on which the strip with the decor will be carried. The created relief surface of the tread concrete is then coloured. The surface with the created pattern is sprayed with paint from the set of nozzles 10.1 and/or nozzles 10.2, placed on the vibropress frame 7. By creating a plastic surface, the individual areas of the decor are coloured unevenly. The following main vibration with punch 3 smooths the paver surface again, but the pattern from the die is highlighted in colour. The result is a coloured surface of the tread layer including the decor.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1-5. (canceled)

6. An apparatus for coloring concrete pavement tread layers comprising:
hoppers for core concrete and tread concrete,
a vibropress with a frame and a punch located above said vibropress, there being a space defined between said vibropress and said punch, and a moveable carrier connected to said frame,
carriages for transporting said core concrete and said tread concrete from said hoppers to said vibropress,
a product mold placeable upon said vibropress for receiving said core concrete and said tread concrete from said carriages and configured for receiving a pressing action from said punch, and,
a paint applicator installed on said moveable carrier, wherein said paint applicator is operable within said space between said vibropress and said punch.

7. The apparatus of claim 6, wherein said paint applicator comprises a plurality of paint nozzles.

8. The apparatus of claim 6, wherein said moveable carrier is programmable for directing said paint applicator to apply a customized paint pattern to a surface of said tread concrete.

9. The apparatus of claim 8, wherein said paint applicator comprises a plurality of paint nozzles.

10. An apparatus for decorating concrete pavement tread layers comprising:
a hopper for core concrete and a hopper for tread concrete,
a vibropress with a frame and a punch located above said vibropress, there being a space defined between said vibropress and said punch, and a moveable carrier connected to said frame,
a core concrete carriage for transporting said core concrete from said hopper for core concrete to said vibropress,
a tread concrete carriage for transporting said tread concrete from said hopper for tread concrete to said vibropress, said tread concrete carriage comprising a roller die for delivering imprinted tread concrete to said vibropress,
a product mold placeable upon said vibropress for receiving said core concrete from said core concrete carriage and said imprinted tread concrete from said tread concrete carriage and configured for receiving a pressing action from said punch, and
a paint applicator installed on said moveable carrier, wherein said paint applicator is operable within said space between said vibropress and said punch.

11. The apparatus of claim 10, wherein said paint applicator comprises a plurality of paint nozzles.

12. The apparatus of claim 10, wherein said moveable carrier is programmable for directing said paint applicator to apply a customized paint pattern to a surface of said imprinted tread concrete.

13. The apparatus of claim 12 wherein said roller die is affixed inside said tread concrete carriage.

14. The apparatus of claim 12, wherein said paint applicator comprises a plurality of paint nozzles.

15. The apparatus of claim 13, wherein said paint applicator comprises a plurality of paint nozzles.
